(19) United States
(12) Patent Application Publication
(10) Pub. No.: US 2006/0104596 A1
(43) Pub. Date: May 18, 2006

(54) Deformable mirror apparatus

(76) Inventors: Charles Askins, Upper Marlboro, MD (US); Perry Skeath, Silver Spring, MD (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/172,664

(22) Filed: Jul. 1, 2005

Related U.S. Application Data
(60) Provisional application No. 60/584,492, filed on Jul. 2, 2004.

(51) Int. Cl. G02B 6/00

(52) U.S. Cl. 385/147

(57) ABSTRACT

An apparatus including a tip-tilt mount, a mirror mounted in the tip-tilt mount, the tip-tilt mount determining an orientation of the mirror, and a forcing frame attached to the mirror and applying at least one bending moment to the mirror. Optionally, the forcing frame includes a vacuum cup connected to the mirror. Optionally, the forcing frame includes a bridge connected to the mirror. Optionally, the apparatus further includes an interferometer including the tip-tilt mirror mount, the mirror, and the forcing frame.

### TECHNICAL FIELD

The present invention relates generally to an apparatus for deforming a mirror, and more particularly to a deformable mirror apparatus for use in an interferometer.

### BACKGROUND ART

Fiber Bragg gratings (“FBGs”) are commonly fabricated by exposing photosensitive glass fiber waveguides to interferometric patterns of laser light with appropriate intensity and photon energy to cause nominally periodic modulations in the index of refraction along the length of the waveguide. The reflectivity spectrum is determined in large part by the spatial period of those modulations. For many applications, these modulations are made to be periodically uniform. However, another class of FBGs includes systematic variation in the period of index modulations along the fiber length. If the period varies smoothly (and typically, monotonically) with length, the grating is said to be “chirped.” Applications of chirped gratings include correction of chromatic dispersion, reflectors and attenuators with expanded spectral width, variable delay lines, and multi-measurand sensors. Chirp may be imposed on a periodically uniform grating after the writing process by non-uniform thermal or mechanical perturbation of the waveguide. Some applications favor having chirp intrinsic to the FBG, so the fabrication process is modified to produce chirp that persists when the fiber is relaxed. Different chirp profiles may be optimal for given applications. With linear chirp, the modulation period is a linear function of position along the length of the grating. Higher order chirp profiles can be used to shape the strength of the reflection spectrum as a function of wavelength, or to impose a specialized, non-linear, time delay function.

Several methods have been proposed and/or demonstrated for producing intrinsic chirp, and representative examples are referenced here:

1) varied average index through varied exposure fluence, using a uniformly periodic intensity field, such as discussed in U.S. Pat. No. 5,363,239 to Mizrahi, et al., incorporated herein by reference;

2) temporally varying period in the intensity field (the exposure geometry changes in synchrony while scanning a small region of exposure along the grating's length) via

a) angular motion of mirrors, such as discussed in Cortes, et al., “Writing of Bragg Gratings with Wavelength Flexibility using a Sagnac type Interferometer and application to FH-CDMA,” Proc. ECOC '98 Vol. 1, pp411-412, incorporated herein by reference; or

b) relative motion of phase mask, such as discussed in Loh, et al., “Complex Grating Structures with Uniform Phase Masks Based on the Moving Fiber-Scanning Beam Technique,” Opt Lett. Vol. 20, 2051-2053, incorporated herein by reference;

3) modified fiber properties in a constant, uniformly periodic intensity field via

a) non-uniform strain applied to the fiber, such as discussed in Hill, et al., “Strain Gradient Chirp of Fibre Bragg Gratings,” Elec. Lett., Vol. 30, 1172-1174, incorporated herein by reference;

b) a tapered core, such as discussed in Byron, et al., “Fabrication of Chirped Bragg Gratings in Photosensitive Fibre,” Elec. Lett., Vol. 29, 1659-1660, incorporated herein by reference;

c) tapered etching of a fiber, and writing while under axial strain, such as discussed in Putnam, et al., “Fabrication of Tapered, Strain-Gradient Chirped Fibre Bragg Gratings,” Elec. Lett. Vol. 31, 309-310, incorporated herein by reference; or

d) curving the fiber in the interference field, such as discussed in Sugden, et al., “Chirped Gratings Produced in Photosensitive Optical Fibres By Fibre Deformation During Exposure,” Elec. Lett. Vol. 30, 440-442, incorporated herein by reference;

4) spatially varying period in a fixed intensity field via

a) direct writing with a chirped phase mask, such as discussed in U.S. Pat. No. 6,567,588 to Unruh, incorporated herein by reference;

b) use of a chirped phase mask as a beam splitter in a multiple-mirror interferometer, such as discussed in Kashyap, “Assessment of Tuning the Wavelength of Chirped and Unchirped Fibre Bragg Grating with Single Phase-Masks,” Elec. Lett., Vol. 34, 2025-2027, incorporated herein by reference; or

c) introduction of lenses or curved mirrors in the path of an interferometer to curve the optical fields, such as discussed in Farries, et al., “Very Broad Reflection Bandwidth (44 nm) Chirped Fibre Gratings and Narrow Bandpass Filters Produced by the Use of an Amplitude Mask,” Elec. Lett. Vol. 30, 891-892, incorporated herein by reference, Garchev, et al., “Wavelength-Tunable Chirped In-Fiber Bragg Gratings Produced with a Prism Interferometer,” Opt. Comm. Vol. 145, 254-258, incorporated herein by reference, and U.S. Pat. No. 5,363,239 to Mizrahi, et al.

U.S. Pat. No. 5,718,738 to Kohnke, incorporated herein by reference, discusses the use of a deformable mirror for producing chirped phase masks as part of a photolithographic process.

### DISCLOSURE OF THE INVENTION

An embodiment of the invention includes an apparatus including a tip-tilt mount, a mirror mounted in the tip-tilt mount, the tip-tilt mount determining an orientation of the mirror; and a forcing frame attached to the mirror and applying at least three bending moments to the mirror. Optionally, the tip-tilt mirror comprises a ported tip-tilt mirror. Optionally, the apparatus further includes an interferometer including the tip-tilt mirror mount, the mirror, and the forcing frame.

Optionally, the forcing frame includes a vacuum cup connected to the mirror. Optionally, the forcing frame includes a bridge connected to the mirror. Optionally, the apparatus further includes a compliant, vacuum seal interposed between the mirror and the vacuum cup. Optionally, the apparatus further includes a pad interposed between the mirror and the bridge.

Optionally, the apparatus further includes a translating actuator, which cooperates with the vacuum cup or with the mirror. For example, the translating actuator includes a pneumatic actuator, a hydraulic actuator, a piezoelectric actuator, a magnetorestrictive actuator, a solenoid actuator, an electric motor, an adjustable spring load, or a thermal expansion actuator.

Optionally, the apparatus further includes a first bending actuator connected to the forcing frame. Optionally, the forcing frame includes a clamping arm. Optionally, the forcing frame includes a second bending actuator connected to the mirror, and a bridge connected to the second bending actuator and the clamping arm. Optionally, the apparatus further includes a pad or an adhesive interposed between the mirror and the second bending actuator. Optionally, the apparatus further includes a pad interposed between the mirror and the clamping arm.

Optionally, the first bending actuator includes a pneumatic actuator, a hydraulic actuator, a piezoelectric actuator, a magnetorestrictive actuator, a solenoid actuator, an electric motor, an adjustable spring load, or a thermal expansion actuator. Optionally, the second bending actuator includes a pneumatic actuator, a hydraulic actuator, a piezoelectric actuator, a magnetorestrictive actuator, a solenoid actuator, an electric motor, an adjustable spring load, or a thermal expansion actuator. Optionally, the translating actuator includes a pneumatic actuator, a hydraulic actuator, a piezoelectric actuator, a magnetorestrictive actuator, a solenoid actuator, an electric motor, an adjustable spring load, or a thermal expansion actuator. An embodiment of the invention allows the inscription of optical fiber Bragg gratings with a user-determined shape and amount of intrinsic chirp by elastically shaping one or more mirrors, which guide one or more beams in an interferometer used to write the gratings. The embodiment defines the desired periodicity of the entire interference field without need for further adjustment during the writing process. That is, chirp is produced, for example, without manipulation of the fiber to apply strain gradients or shaping, since in particular applications, high fiber strength must be maintained. Use of the embodiment facilitates writing fiber Bragg gratings using, for example, scanned exposures, cumulative exposures, or a single, brief exposure. The arbitrarily curved mirror of the embodiment creates a curved wavefront in one or both intersecting beams of the interferometer used to form the nominally periodic optical intensity pattern. Curvature may be easily varied to produce different rates of chirp, for example, without disturbing the alignment of the interferometer. This combination of features, for example, makes certain embodiments of the invention suitable for use with writing chirped gratings during the optical fiber draw process with a pulsed exposure, or with more conventional exposure conditions.

Fiber Bragg gratings are often produced with a multiple-mirror interferometer because of its versatility, particularly in comparison to the interferometric near field of a phase mask. An embodiment of the invention is suitable in such multiple-mirror interferometers used for writing FBGs, including those using conventional beam splitters, and in the Kashyap design, where a phase mask is used as the beam splitter, discussed in Kashyap, Elec. Lett., Vol. 32, 2025-2027.

### BRIEF DESCRIPTION OF THE DRAWINGS

FIG. 1(a) shows a line representing a mirror having no bending moments.

FIG. 1(b) shows an illustrative grating pitch graph for a mirror having no bending moments.

FIG. 1(c) shows an illustrative reflectivity spectrum graph for a mirror having no bending moments.

FIG. 2(a) shows a line representing a mirror having three bending moments.

FIG. 2(b) shows an illustrative grating pitch graph for an interferometer using a mirror having three bending moments.

FIG. 2(c) shows an illustrative reflectivity spectrum graph for a mirror having three bending moments.

FIG. 3(a) shows an embodiment of the invention, which is capable of imposing three bending moments, in a relaxed position.

FIG. 3(b) shows an embodiment of the invention, which is capable of imposing three bending moments, in a flexed position.

FIG. 4(a) shows a line representing a mirror having four bending moments.

FIG. 4(b) shows an illustrative grating pitch graph for an interferometer using a mirror having four bending moments.

FIG. 4(c) shows an illustrative reflectivity spectrum graph for a mirror having four bending moments.

FIG. 5(a) shows an embodiment of the invention, which is capable of imposing four bending moments, in a relaxed position.

FIG. 5(b) shows an embodiment of the invention, which is capable of imposing four bending moments, in a flexed position.

FIG. 6(a) shows a line representing a mirror having five bending moments.

FIG. 6(b) shows an illustrative grating pitch graph for an interferometer using a mirror having five bending moments.

FIG. 6(c) shows an illustrative reflectivity spectrum graph for a mirror having five bending moments.

FIG. 7 shows an embodiment of the invention, which is capable of imposing five bending moments, in a relaxed position.

### BEST MODES OF CARRYING OUT THE INVENTION

An embodiment of he invention allows the photo-induced inscription of optical fiber Bragg gratings (“FBGs”) with a user-selected spectral shape and degree of intrinsic chirp with the use of a reversibly adjustable optic. For example, the embodiment is to be applied to one or more beams in an interferometer used to write the gratings. An embodiment of the invention permits up to the entire cross section of the affected beam to have its wavefront appropriately shaped, so that up to all regions of the writing exposure are simultaneously conditioned to produce the desired chirp. An embodiment of the invention enables rapid production of high strength, chirped FBGs by avoiding complicated manipulation of the fiber. An embodiment of the invention permits settings for chirp to be rapidly varied between successive gratings without otherwise disturbing or misaligning the interferometer. The range of adjustment of an embodiment of the invention includes settings that do not produce chirp. An embodiment of the invention provides this capability both for writing processes involving extended optical exposures (e.g., multiple short exposures or long continuous exposures), and processes for high throughput production using one or more brief exposures. Specific chirp profiles (e.g., linear or quadratic) may be produced which suit specific applications.

Grating writing generally includes focusing of the laser beams in the direction perpendicular to the fiber's axis to enhance intensity. An embodiment of the invention, which produces bending moments, may be configured to produce the majority of the bending in one plane, which plane includes the long axis of the fiber to be exposed. A bending moment, for example, is a localized force applied to a structure, at least three of such bending moments being required to cause bending of the structure. Bending moments, for example, are applied in a direction nominally perpendicular to a reflective surface of the mirror to be used for generating a desired chirp profile.

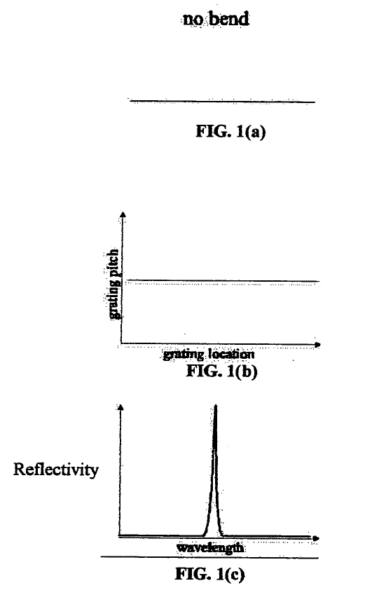

Different chirp profiles may be produced by details of how bending forces are transferred from the forcing frame to the mirror. FIG. 1(a) shows a mirror with “no bend.” That is, the mirror surface is flat. The flat mirror surface corresponds to an exposure without chirp. The grating pitch is shown to be constant along the length of the grating, as shown in FIG. 1(b). An embodiment of the invention is compatible with an intensity profile, such as a tapered intensity profile, to produce an apodized grating. The narrow reflectivity spectrum resulting from the flat mirror surface (i.e., unchirped case) and apodization is shown in FIG. 1(c).

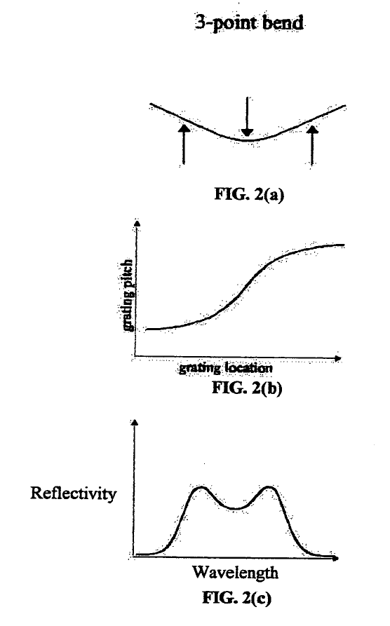

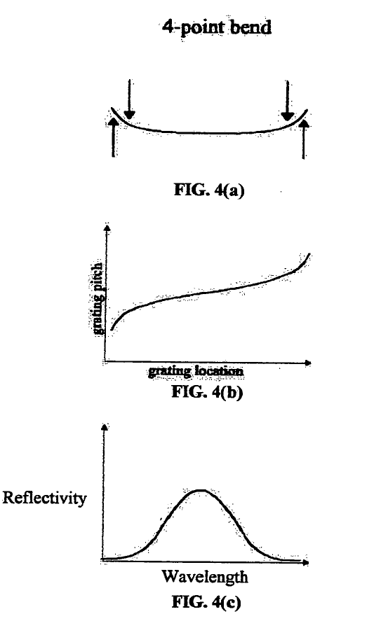

In contrast, 3-point bending, shown in FIG. 2(a), causes a paraboloid-like curvature of the mirror surface. For clarity, N-point bending includes bending at a point or along a line necessarily including the point. So, 3-point bending, for example, includes bending at three points or includes bending along three lines. This curved wavefront can interfere with a flat wavefront to produce a rapidly varying grating pitch at the center of the grating, and slower variation at the edges. The resulting spectrum shows much broadening in FIG. 2(b), relative to the un-chirped case, and reflectivity, shown in FIG. 2(c) is reduced where curvature is highest. An illustrative embodiment of the invention, which approximates 3-point bending, is shown in FIGS. 4(a) and (b). By way of illustrative context, an embodiment of the invention includes a deformable mirror 10 (“DM”), for example, for producing an adjustably curved wavefront in an interferometer, the curved wavefront causes a smoothly varying periodicity in the interferometric optical field; the intensity modulations produce similarly mapped index modulations in a photosensitive optical waveguide, constituting a chirped Bragg grating. Acceptable mirrors 10 are uniform (or regular) in thickness, width, or length. Alternatively, acceptable mirrors 10 are optionally not uniform (or regular) in thickness, width, or length. Mirrors with varied width or varied thickness produce more extreme curvatures or more exotic curvatures than are easily obtained with a conventional shape (e.g., circular or rectangular with constant thickness).

The DM 10, for example, is either added to one or both paths of an interferometer, or substitutes for one or more mirrors, which form the interferometer. Altering the shape of the mirror's surface produces a change in the curvature of the wavefront of the light beam reflected from the mirror 10, thereby producing a selectable degree and profile of chirp in the grating. The mirror 10 is optionally adjusted to be optically flat, which easily enables the formation of gratings having no chirp. The instant invention effects a curvature of the DM 10 by imposing adjustable bending forces on the mirror by a forcing frame coupled thereto. For example, the bending forces or moments impart a flexure in the mirror 10 on the order of one micron. A multiplicity of bending modes is optionally produced by impressing a plurality of bending forces between the forcing frame and the mirror 10. The forcing frame and mirror 10 are mountable, for example, by the edges of the mirror in a standard tip-tilt mirror mount or positioner 30 to simplify alignment of the interferometer. Optionally, the tip-tilt mirror mount 30 is ported, having contact with the DM 10 only at the mount's periphery, and minimally obstructing access to either the front or back surface of the mirror. For example, the tip-tilt mirror mount 30 is capable of a deflecting the DM 10 on the order of microns to multiple millimeters. The mirror 10, which is optically flat in the absence of forcing, allows adjustment to the non-chirp condition by setting the bending force to zero.

According to an embodiment of the invention, bending is produced by either pushing or pulling the center of the DM 10 while supporting the edges in opposition. For example, the amount of bending force is adjusted by the forcing frame between the mirror and the forcing frame, which allows independent change in bending without imposing torque or thrust on any support (e.g., the tip-tilt mirror mount 30) which carries the mirror 10 and the forcing frame.

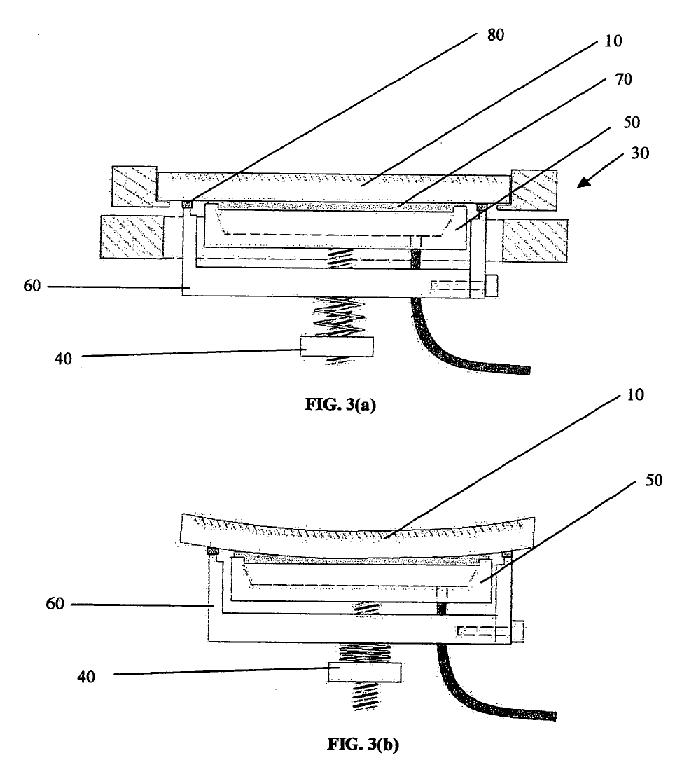

In an embodiment shown in FIGS. 3(a) and (b), the forcing frame includes a vacuum cup 50 attached to the back of the mirror 10 and spans the mirror from side to side. In operation of this embodiment, the vacuum cup 50 pulls the mirror 10 against a bridge 60 that contacts the mirror at its sides.

Optionally, the vacuum cup 50 has a rectangular, operative end. The operative end has a first pair of walls parallel to a width of the mirror 10, and a second pair of walls parallel to a length of the mirror. For example, the first pair of walls is taller than the second pair of walls. Suitable standard elastomers 70 are optionally molded to the walls of the vacuum cup 50, to the mirror 10, or both to produce a seal for maintaining the vacuum. Optionally, the differently sized vacuum cup walls cause more vacuum deformation along the first pair of walls than the second pair of walls, whereby deformation of the mirror is at least substantially in one dimension. In operation, the elastomer vacuum seal 70 also acts as force distributing cushioning to prevent undesired deformation of the mirror 10 due to imperfect surfaces on the mirror or vacuum cup 50. For the same reason, contact between the bridge 60 and the mirror 10 is optionally mediated by a connector 80, such as an elastomeric pad or an elastomeric adhesive.

Optionally, the forcing frame includes a translating actuator 40 optionally connected to the vacuum cup 50 or to the mirror. The translating actuator 40, for example, includes a pneumatic actuator, a hydraulic actuator, a piezoelectric actuator, a magnetorestrictive actuator, a solenoid actuator, an electric motor, a thermal expansion actuator, adjustable spring load, or other actuator that generates a pushing or pulling force along an axis. Force from the translating actuator 40, pulls the center of the mirror 10 towards its back surface, while the bridge 60 directs an equal force along opposing edges of the mirror toward its front surface, producing a concave mirror surface.

In an alternative embodiment, the forcing frame does not include a vacuum cup, and does include the elastomeric adhesive 80. Force from the translating actuator 40, pushes the center of the mirror 10 towards its front surface, while the bridge 60 directs an equal force along opposing edges of the mirror toward its back surface, producing a convex mirror surface.

In yet another embodiment, the forcing frame includes the vacuum cup 50, and the elastomeric adhesive 80 between the bridge 60 and the mirror 10. Vacuum is not applied such that the vacuum cup 50 acts as a pad. In such an embodiment, the translating actuator 40 applies a pushing force against the vacuum cup 50, and hence the mirror 10.

Optionally, one end of the bridge is free to pivot relative to the main part of the bridge so that no machining errors induce unwanted torsion of the face of the mirror. This pivoting degree of freedom is optionally available for actuation, such as via a pneumatic or hydraulic actuator or adjustable spring load (not shown), should fine adjustment of torsion be necessary, for example, to correct mirror figure error.

While the curvature shape is constant, the scale of the curvature varies in direct proportion to the applied force. So, for example, two parallel incident light rays would continue parallel after reflecting from the flat mirror 10 in FIG. 3(a). In FIG. 3(b), the curved, or flexed, mirror 10 would convert the parallel input rays to non-parallel reflected rays, indicative of a curved wavefront. Since the bending forces do not react against the tip-tilt mirror mount 30, the degree of chirp may be varied without disturbing mirror alignment. Conversely, mirror alignment is optionally varied without altering the degree of curvature (or, by extension, chirp). The embodiment shown in FIGS. 3(a) and (b), for example, allows the chirping adjustment to be removed or attached without disturbing the mirror 10.

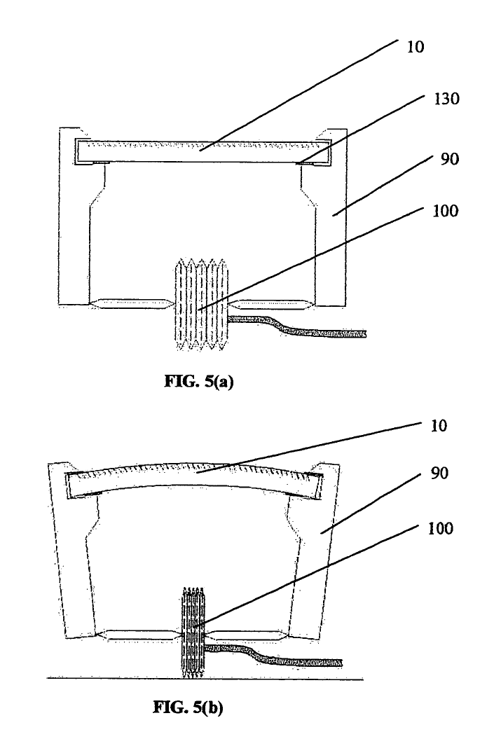

A different mirror curvature shape is possible with 4-point bending, as shown in FIGS. 4(a)-(c). For example, the DM 10 is optionally bent by opposing forces, which are slightly offset near the edges. For example, one direction of force is applied perpendicular to the mirror surface at a distance in from the edge, for example, equal to about 10 to 20 percent of the mirror's length at both edges, and equal opposing force is applied nearly at both of the mirror's edges, perpendicular to the mirror surface. This produces relatively high curvature near the mirror's edge, and nearly constant curvature over most of the mirror's length. Curvature is minimal at the center. The resulting spectrum is broadened, with reflectivity peaked near the center. An illustrative embodiment of the invention, which approximates 4-point bending, is shown in FIGS. 5(a) and (b). In this embodiment, the forcing frame, for example, includes one or more clamping arms 90 that clamp the DM 10 and a first bending actuator 100 connected to the clamping arms. The first bending actuator 100 includes, for example, a pneumatic actuator, a hydraulic actuator, a piezoelectric actuator, a magnetorestrictive actuator, a solenoid actuator, an electric motor, a thermal expansion actuator, adjustable spring load, or other actuator capable of generating a pushing or pulling force along an axis. An elastomeric pad 130 is optionally interposed between the clamping arms 90 and the front and/or back of the mirror 10 to avoid distortion from machining inaccuracies.

Bend forces are imposed near the edges of the mirror by the clamping arms 90. In FIG. 5(b), for example, a pneumatic force is applied by the first bending actuator 100, shown illustratively as tensioning bellows, attached between the clamping arms 90. For example, partially evacuating the tensioning bellows produces a convex bending of the mirror 10. Incident parallel rays would be converted to non-parallel rays by the curved mirror 10. Alternatively, if the first bending actuator includes thrust bellows, and contact distances between the clamping arms 90 and the mirror's edges are reversed, expanding the thrust bellows produces a concave bending of the mirror 10. Optionally, in such an alternative, the apparatus includes a tension spring attached to points on the clamping arms next to mirror to hold the clamping arms onto the mirror.

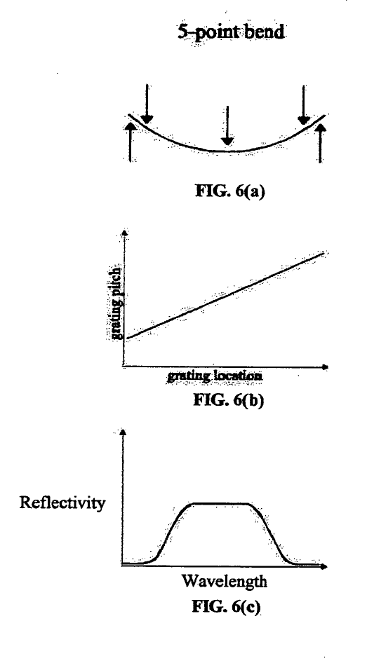

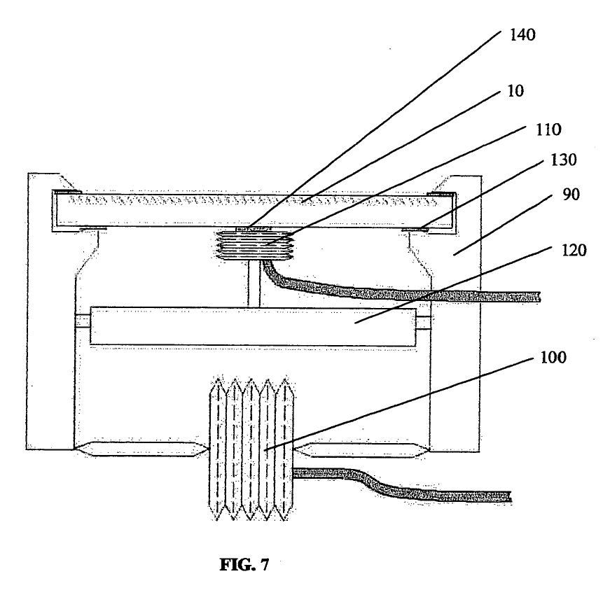

As another example, 5-point bending allows for any combination of 3-point bending with 4-point bending. With respect to such 5-point bending, FIGS. 6(a)-(c) shows that nearly constant curvature produces nearly linear chirp. The resulting linearly chirped spectrum (with apodization) is shown in FIG. 6(c). An illustrative embodiment of the invention, which approximates 5-point bending, is shown in FIG. 7. A second bending actuator 110 is placed near the center of the mirror 10, and reacts against a loosely mounted thrust bridge 120 connected to the clamping arms 90. The second bending actuator 110 includes, for example, a pneumatic actuator, a hydraulic actuator, a piezoelectric actuator, a magnetorestrictive actuator, a solenoid actuator, an electric motor, a thermal expansion actuator, adjustable spring load, or other actuator capable of generating a pushing or pulling force along an axis. An elastomeric pad 130 is optionally interposed between the clamping arms 90 and the front and/or back of the mirror 10 to avoid distortion from machining inaccuracies. A connector 140 is optionally interposed between the back of the mirror 10 and the second bending actuator 110 to avoid distortion from machining inaccuracies. The connector 140, for example, includes an elastomeric pad, when thrusting forces are used with the second bending actuator 110. Alternatively, the connector 140, for example, includes an elastomeric adhesive, when tensioning forces to be applied by the second bending actuator 110. Adjustment of pressure on the first bending actuator 100 and on the second bending actuator 110 allows scaling the 3-point bending and 4-point bending components to produce the desired mirror shape.

For example, the amount of mirror deflection is determined by applied force rather than precise positioning or adjustment of the actuators' extension length. Because pneumatic force or spring loading, for example, can be easily maintained at a constant level and the elastic properties of the mirror are insensitive to typical environmental fluctuations, an embodiment of the invention using such actuation produces extremely stable and reproducible curvature. Proof of curvature stability includes growth rates of grating reflectivity appearing substantially equivalent for gratings written with extended exposures of 10's of minutes with and without applied bending forces.

For an illustrative 3-point bending embodiment, a nominal chirp rate of 1.5 nanometer of Bragg wavelength per centimeter (1.5 nm/cm) of grating length results from a 3 inch diameter mirror, 0.25 inches thick loaded by 28 pounds of force. In the illustrative geometry used, the central portion of the mirror surface curved with a radius of about 112 meters.

For an illustrative 4-point bending embodiment, 0.75 nm/cm results from the same mirror and 5 pounds of tensioning force on the clamping arms. The radius of curvature near the mirror's center is about 230 meters.

An embodiment of the invention has advantages over methods, which vary the optical geometry during a progressive exposure; with the embodiment, the interference pattern is simultaneously defined over entire length of the grating. This allows exposure along the entire length to occur at once. This is useful, when the grating is written with one or few brief exposures.

An embodiment of the invention does not require the exposed waveguide to be specially configured. So, it has advantages over methods, which achieve chirp by preparing the exposed waveguide with non-uniform geometry, strain, temperature, etc. Minimal handling and preparation is important for rapid production and for preserving the mechanical strength of optical fibers.

An embodiment of the invention is advantageous compared to methods, which use highly-specific optical elements (e.g., chirped phase masks, lenses or mirrors with fixed curvature) to define a particular chirp through shaping the interference field, because the embodiment allows the interference field to be adjusted to enable a wide range of chirp designs (e.g., linear, sigmoidal, etc). This is useful for manufacturing different types of gratings having continuously selectable types of chirp.

Compared with the use of movable lenses to adjustably shape the interferometric optical field to produce chirp, an embodiment of the invention does not require additional optical surfaces in the interferometer because the embodiment operates by modifying one or more of the mirrors conventionally included in the interferometer.

An embodiment of the invention produces chirp by introducing only the minimum wavefront curvature required to produce the desired chirp. In contrast, a lens method relies on the differential curvature of two highly curved wavefronts, and is accompanied by undesirable alterations of the light beams such as partial reflections, gross changes in optical path length, and redistribution of optical intensity (i.e., the cross section of the laser beam is sharply altered by focusing). Because the embodiment of the invention uses the minimal necessary wavefront curvature, the cross-section of the interfering beams are essentially unchanged; this allows fully independent control of beam cross section. The relatively high curvatures of the lens methods result in appreciable differences in fringe spacing with position near the location of the exposed waveguide, therefore more difficulty in calibration to specific Bragg wavelengths. The low-curvature wavefronts of the embodiment of the invention allow greater precision in setting Bragg wavelength because of much reduced sensitivity to position. High wavefront curvature also produces an appreciable variation in the tilt of the interference fringes relative to the waveguide along its length; the embodiment of invention avoids this complication.

In an embodiment of the invention, no precision positioning devices are needed to produce accurate and stable adjustments of chirp. While conventional precision positioners may be used successfully, the amount of mirror deflection may be determined with an embodiment of the invention by applied force rather than precise positioning (as might be the case with micrometers or piezoelectric elements). Because pneumatic force or spring loading, for example, can be easily maintained at a constant level and the elastic properties of the mirror are insensitive to typical environmental fluctuations, the embodiment produces extremely stable and reproducible curvature.

In an embodiment of the invention, adjustment of chirp does not disturb the alignment of the mirror because the adjustment forces act in balance against the stiffness of the mirror, pneumatic or hydraulic force, for example, is applied in a manner that does not apply thrust or torque against the tip-tilt mirror mount or positioner, which holds the mirror. This permits real-time adjustment of the curvature (or chirp) during a sequence of production without requiring corrective realignment of the interferometer for different types of production. Conversely, tip-tilt alignment of the mirrors is also possible without altering the curvature (or, by extension, chirp) setting.

It is, of course, recognized that although three types of bending apparatuses were selected for discussion because of their simplicity, the concept of determining mirror curvature by selective application of bending forces can be generalized to a variety of curvature shapes. Additionally, it is, of course, recognized that although uniform or symmetrical bending forces have been discussed above, an embodiment of the instant invention generates asymmetrical bending forces. In such an embodiment, for example, the bending actuator 110 attaches to the two clamping arms 90 at different distances from the mirror 10 so as to apply differing forces on differing regions of the mirror 10. Obviously, many modifications and variations of the present invention are possible in the light of the above teachings. It is therefore to be understood that the scope of the invention should be determined by referring to the following appended claims.

What is claimed is:

1. An apparatus comprising:
a tip-tilt mirror mount;
a mirror mounted in said tip-tilt mirror mount, said tip-tilt mirror mount determining an orientation of said mirror; and
a forcing frame attached to said mirror and applying at least three bending moments to said mirror.

2. The apparatus according to claim 1, wherein said tip-tilt mirror mount comprises a ported tip-tilt mirror mount.

3. The apparatus according to claim 1, wherein said forcing frame comprises:
a vacuum cup connected to said mirror.

4. The apparatus according to claim 1, wherein said forcing frame comprises:
a bridge connected to said mirror.

5. The apparatus according to claim 3, further comprising:
a compliant, vacuum seal interposed between said mirror and said vacuum cup.

6. The apparatus according to claim 4, further comprising:
one of a pad and an adhesive interposed between said mirror and said bridge.

7. The apparatus according to claim 3, wherein said forcing frame further comprises:
a translating actuator, which cooperates with said vacuum cup.

8. The apparatus according to claim 1, comprising:
a first bending actuator connected to said forcing frame.

9. The apparatus according to claim 8, wherein said forcing frame comprises
a clamping arm.

10. The apparatus according to claim 9, wherein said forcing frame comprises:
a second bending actuator connected to said mirror; and
a bridge connected to said second bending actuator and said clamping arm.

11. The apparatus according to claim 10, further comprising:
one of a pad and an adhesive interposed between said mirror and said second bending actuator.

12. The apparatus according to claim 10, further comprising:
a pad interposed between said mirror and said clamping arm.

13. The apparatus according to claim 8, wherein said first bending actuator comprises one of a pneumatic actuator, a hydraulic actuator, a piezoelectric actuator, a magnetorestrictive actuator, a solenoid actuator, an electric motor, an adjustable spring load, and a thermal expansion actuator.

14. The apparatus according to claim 10, wherein said second bending actuator comprises one of a pneumatic actuator, a hydraulic actuator, a piezoelectric actuator, a magnetorestrictive actuator, a solenoid actuator, an electric motor, an adjustable spring load, and a thermal expansion actuator.

15. The apparatus according to claim 7, wherein said translating actuator comprises one of a pneumatic actuator, a hydraulic actuator, a piezoelectric actuator, a magnetorestrictive actuator, a solenoid actuator, an electric motor, an adjustable spring load, and a thermal expansion actuator.

16. The apparatus according to claim 1, further comprising an interferometer comprising said tip-tilt mirror mount, said mirror, and said forcing frame.

17. The apparatus according to claim 1, wherein said forcing frame comprises:
a translating actuator, which cooperates with said mirror.
